(19) United States
(12) Patent Application Publication
(10) Pub. No.: US 2006/0249243 A1
(43) Pub. Date: Nov. 9, 2006

(54) Method of manufacturing transparent ball with color image

(76) Inventor: Tian-Lai Cheng, Taichung (TW)

Correspondence Address: LEONG C LEI, PMB # 1008, 1867 YGNACIO VALLEY ROAD, WALNUT CREEK, CA, 94598, US

(21) Appl. No.: 11/124,209

(22) Filed: May 9, 2005

(51) Int. Cl. B32B 38/00; B32B 38/04; B32B 37/16

(52) U.S. Cl. 156/93; 156/265; 156/245; 156/297

(57) ABSTRACT

A method of manufacturing transparent ball with color image. The method of forming the laminate layer of the ball includes injecting or hot pressing a transparent and a printed thin film as the laminate layer; cutting the laminate layer into a plurality of plates of the surface of the ball; adhering the plates onto the enhanced layer so as to form the color image which allows the direct vision of the interior of the ball from the outermost layer.

### BACKGROUND OF THE INVENTION

(a) Technical Field of the Invention

The present invention relates to manufacturing of transparent ball with color image, and in particular, a color image between an enhanced layer and a transparent layer of the ball.

(b) Description of the Prior Art

The method of manufacturing balls such as basketballs, soccer balls, volley balls, handballs, captain balls, American footballs, Rugby, training balls, etc., includes a hand stitching method and a non-hand stitching method. The structure of non-hand stitching includes wrapped layer and rubber bladder formation. The color images are printed onto the surface of the ball and the drawbacks include the fading of the colors of the images, the quality of the images is poor and above 3 million pixel image cannot be printed, the discontinue layer of the ball affecting the sight of the ball; and the multi-color screen printing is expensive.

U.S. Pat. No. 5,320,345 discloses a method of forming color images and then transferring the images onto the inner side of the transparent rubber plate. The drawbacks include high resolution (above 3 million pixel) images cannot be obtained, the cost of production is high, in particular, when a plurality of colors is needed; larger surface cannot be printed; and the procedure is complicated.

### SUMMARY OF THE INVENTION

The primary purpose of the present invention is to provide a method of manufacturing a transparent, color image ball including an inner ball inflated bladder layer, an enhanced layer, and a laminate layer, the method of manufacturing the laminate layer comprising the steps of injecting a transparent and a color thin film as the laminate layer; cutting the laminate layer into a plurality of plates of the surface of the ball; adhering the plates onto the enhanced bladder layer so as to form the color image which allows the direct vision of the interior of the ball from the outermost layer.

Yet another object of the present invention is to provide a method of manufacturing a transparent, color image ball including an inner ball bladder layer, an enhanced layer, and a laminate layer, the method of manufacturing the laminate layer comprising the steps of hot pressing to form a transparent layer and a color thin film as the laminate layer; cutting the laminate layer into a plurality of plates of the surface of the ball; adhering the plates onto the enhanced bladder layer; placing the plates with the enhanced bladder layer of step (c) into a two semi spherical mold to proceed with vulcanization so as to form the color image which allows the direct vision of the interior of the ball from the outermost layer.

The porous film materials include synthetic papers, fiber, plastic film and plastic material including polyethylene, polypropylene, PET, TPU, PVC, Thermoplastic Elastomer (TPE).

The method of laminate formation includes injection molding hot press molding method, high periodic wave method, and extruding process method.

In accordance with the present invention, the transparent layers include Poly Vinyl Chloride (PVC), Styrene-Butadiene-Styrene (SBS), Styrene-Isoprene-Styrene (SIS), Styrene-Ethylene Butylene Styrene (SEBS), Styrene-Ethylene Propylene Styrene (SEPS), Thermoplastic Polyurethane (TPU), Poly Olefin Elastomer (POE), Ethylene-Propylene Rubber (EPR), Ethylene-Propylene-diene Rubber) EPDM, Butadiene Rubber (BR), Solution Styrene-Butadiene Rubber (SSBR), Isoprene Rubber (IR), Polyurethane Rubber (PUR). If these transparent layers need to be undergone a vulcanization process, before the process of lamination, peroxides or resin can be added as a cure agent or a crossliking agent. The peroxide is selected from the group consisting of DCP (dicumyl peroxide), BPO (Benzo peroxide), MEKPO (methyl ethyl ketone peroxide), etc. The amoLmt of additive added is ranging from 0.1 to 8 parts per hundred resin.

The advantages of the present invention include:
1. The quality of printing is excellent and the color resolution is above 3 millions pixels.
2. The printed layer is between the transparent layer and bladder and therefore the color image can be seen directly to the interior and never fading by normal abrasion.
3. The porous film allows printing with automatic machine and in the course of lamination, there is no limitation because the adhesion force is excellent.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to die detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart of conventional method of manufacturing ball.

FIG. 2 is a flowchart of manufacturing process for porous film in accordance with the present invention.

FIG. 3 is a flowchart showing the manufacturing of the laminate layer of the present invention.

FIGS. 4A and 4B is a sectional view of the laminate layer of the present invention.

FIG. 5 is a flowchart of manufacturing ball in accordance with the present invention.

FIGS. 6A, 6B, and 6C is a sectional view of the ball in accordance with the present invention.

FIG. 7 is a perspective view of the ball in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

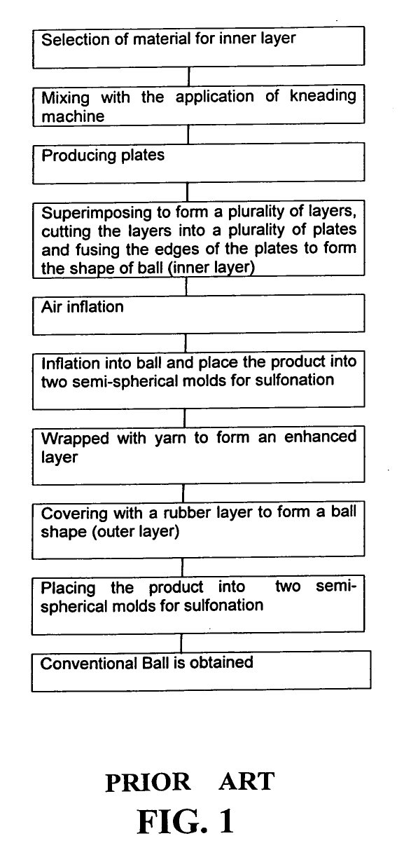

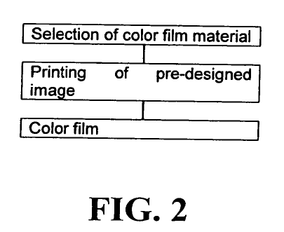

FIG. 1 discloses a conventional ball manufacturing process. FIG. 2 shows the flowchart of manufacturing of color film. Porous film material is selected and the color film is formed by printing. The color printing is done by automatic device.

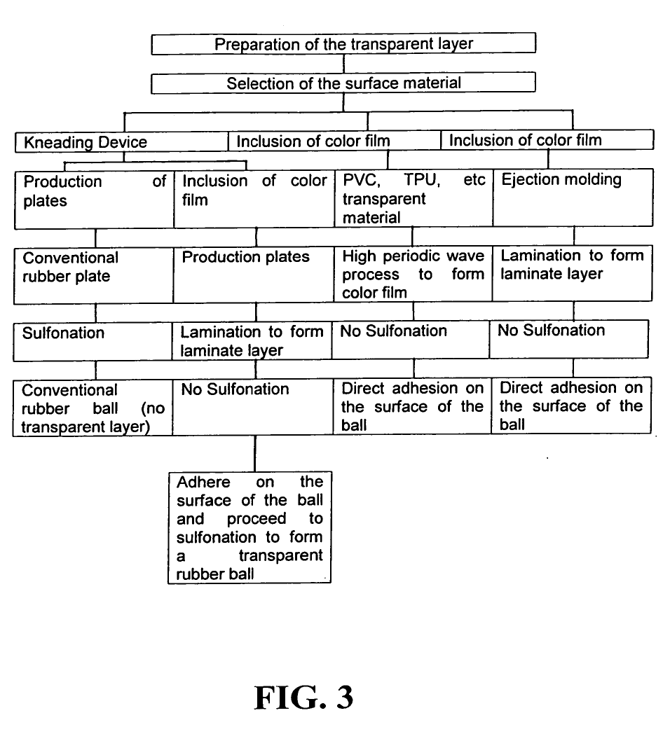

FIG. 3 is a flowchart showing the lamination process of the color film and the transparent layer. The method of lamination varies according to the different of material used. For instance, the first type of lamination is by injection molding. The color printed film is placed into the injection mold and after the plastic injection molding laminate layer or laminated layer of color image is obtained. No vulcanization process is required.

The second method is by high periodic wave melting. PVC or TPU film is selected as the transparent material. Similarly, color film is added and by way of high periodic wave melting, a laminate layer with color image is obtained. The laminate layer is cut and stitched one piece by one piece then adhered onto the enhanced bladder layer to form hand stitching ball.

The third method of lamination is first forming into a plate body as the transparent layer 10 and together with color film 21 to place into a flat press. By means of the flat press, color image laminate layer 20. The laminate layer 20 is finally adhered onto the enhanced bladder layer and undergone a vulcanization process to form a transparent laminate rubber ball.

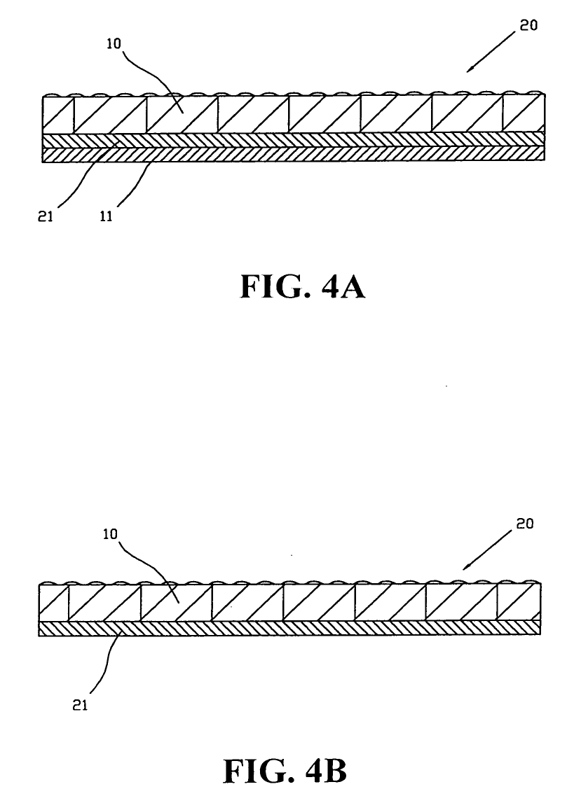

Referring to FIGS. 4A and 4B, the laminate layer 20 consists of three layers, a transparent layer 10, a bottom layer 11 and an intermediate color film 21. FIG. 4B is a two-layer structure, where there is no bottom layer 11. In accordance with the present invention, the thickness of the laminate layer 20 is between 0.5 to 3.0 mm. Therefore, the number of the laminate layer 20 is at least two, including a transparent layer 10 and a color film 21.

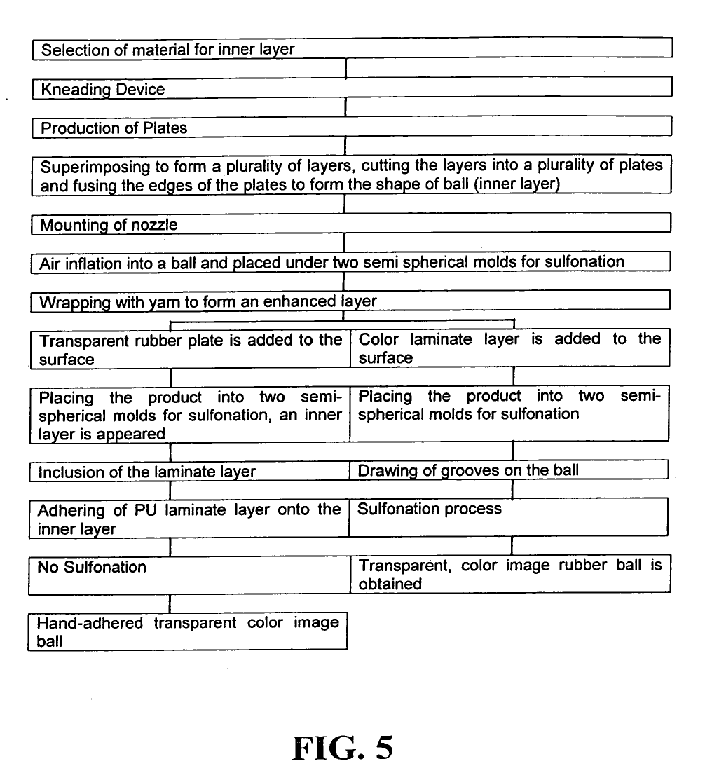

Referring to FIG. 5, in the ball manufacturing process where vulcanization process is needed at the final step. After the enhanced bladder layer is completed, the third method of lamination is introduced. The complete color image laminate layer is place within two semi spherical molds to proceed with vulcanization. The surface of the ball after vulcanization has a groove which allows positioning and provides aesthetic appearance.

In the process where vulcanization is not needed, the surface of the wrapped bladder is covered with an enhanced rubber layer. After vulcanization, a groove is formed which divides the ball body into 8 regions. After that, PU adhesives are used to stick onto the laminate layer to form into a leather ball.

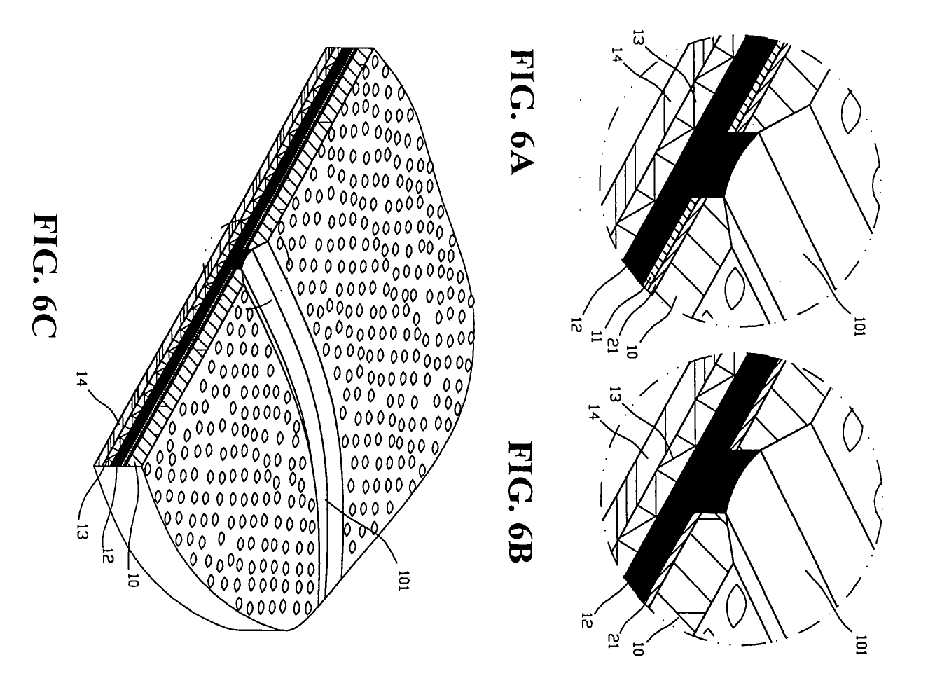

Referring to FIGS. 6A, 6B, and 6C there is shown the structure of the entire ball. The ball has a groove 101 and an inner layer 14 which is used for filing air, a wrapped enhanced bladder layer 13, an inner layer 12 and a color laminate bladder layer 20. The laminate layer 20 is a transparent layer 10 and a bottom layer 11 covered the color film 21. In the figure, in view B, the laminate layer 20 includes the transparent layer 10 and a color film 21.

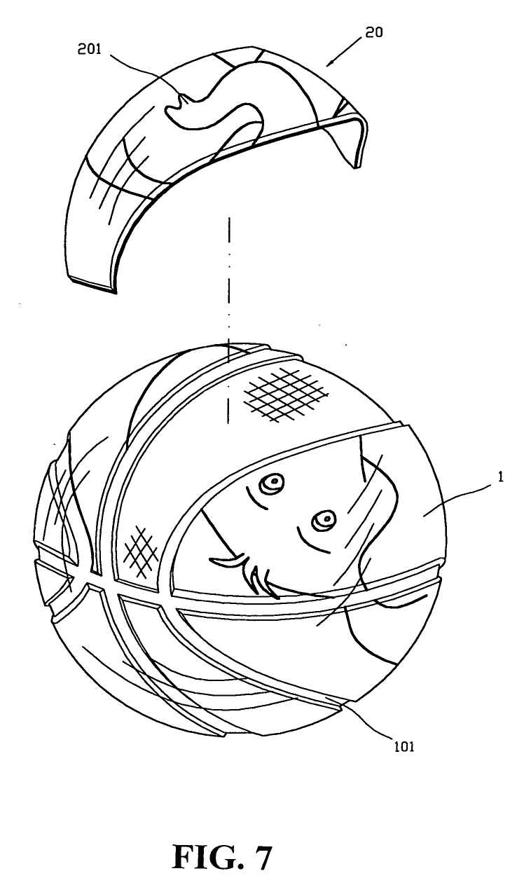

FIG. 7 shows a perspective view of the ball having color image. The laminate layer is adhered onto the ball. The color image is placed into the interior of the transparent layer 10, and the color image is not damage and the image is real.

In accordance with the present invention, the color film can be automatically printed using printing device and the quality of the image is above 3 million pixels.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of manufacturing a transparent, color image ball including an inner bladder layer, an enhanced layer, and a laminate layer, the method of manufacturing the laminate layer comprising the steps of:
a. injecting a transparent and a color thin film as the laminate layer;
b. cutting the laminate layer into a plurality of plates of the surface of the ball;
c. adhering the plates onto the enhanced bladder layer so as to form the color image which allows the direct vision of the interior of the ball from the outermost layer.

2. A method of manufacturing a transparent, color image ball including an inner bladder layer, an enhanced layer, and a laminate layer, the method of manufacturing the laminate layer comprising the steps of:
a. hot pressing to form a transparent layer and a color thin film as the laminate layer;
b. cutting the laminate layer into a plurality of plates of the surface of the ball;
c. adhering the plates onto the enhanced bladder layer;
d. placing the plates with the enhanced bladder layer of step (c) into a two semi spherical mold to proceed with vulcanization so as to form the color image which allows the direct vision of the interior of the ball from the outermost layer.

3. The method of claim 1, wherein the plates are stitched one edge by one edge to each other then wrapped and adhering the enhanced bladder to form a sewing ball.

4. The method of claim 1, wherein the manufacturing of the laminate layer is done by high periodic wave method.

5. The method of claim 1 or 2, wherein the color film is a porous film material printed with images.

6. The method of claim 1 or 2, wherein the laminate layer formed from the cut plates contains at least two.

7. The method of claim 1 or 2, wherein the porous film material includes papers, synthetic papers, fiber, plastic film and plastic material including polyethylene, polypropylene, PET, TPU, PVC, TPE.

8. The method of claim 1 or 2, wherein the transparent layer materials include PVC, SBS, SIS, SEBS, SEPS, TPU, POE, EPR, EPDM, BR, SSBR, IR, PUR.
